(19) United States
(12) Patent Application Publication
(10) Pub. No.: US 2026/0201241 A1
(43) Pub. Date: Jul. 16, 2026

(54) RELATIVE PERMEABILITY MODIFIER FOR SUBTERRANEAN FORMATION

(71) Applicant: Halliburton Energy Services, Inc., Houston, TX (US)

(72) Inventors: Larry Steven Eoff, Houston, TX (US); Jason Adam Denny, Houston, TX (US)

(21) Appl. No.: 19/025,431

(22) Filed: Jan. 16, 2025

(51) Int. Cl. C09K 8/508; C08F 226/02; E21B 33/138

(52) U.S. Cl. CPC C09K 8/5083; C08F 226/02; E21B 33/138; C08F 2800/10

(57) ABSTRACT

Improved methods of treating water and hydrocarbon producing subterranean formations to reduce the water permeability thereof are provided. The methods comprise introducing into the formation a water flow resisting chemical which attaches to adsorption sites on surfaces within the porosity of the formation and reduces the water permeability thereof without substantially reducing the hydrocarbon permeability thereof. The water flow resisting chemical is comprised of a polymer of at least one hydrophilic monomer and at least one hydrophobic monomer.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND

The present disclosure relates generally to methods of treating a water and hydrocarbon producing subterranean formation to reduce the water permeability (e.g., permeability to aqueous solution) thereof without substantially reducing the hydrocarbon permeability (e.g., permeability to hydrocarbons) thereof.

### BRIEF DESCRIPTION OF THE DRAWINGS

Illustrative examples of the present disclosure are described in detail below with reference to the attached drawing FIGURE, which is incorporated by reference herein, wherein:

FIG. 1 is a schematic of a wellbore servicing system, according to embodiments of this disclosure.

The illustrated FIGURE is only exemplary and are not intended to assert or imply any limitation with regard to the environment, architecture, design, or process in which different examples may be implemented.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

It should be noted that when “about” is used herein at the beginning of a numerical list, “about” modifies each number of the numerical list. Further, in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, particle sizes, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the illustrative embodiments described herein. At the very least, and not as an attempt to limit the application of the doctrine of equivalents to the scope of the claim, each numerical parameter should at least be construed in light of the number of reported significant digits and by applying ordinary rounding techniques. The term “about” as used herein can thus allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present disclosure. At the very least, and not as an attempt to limit the application of the doctrine of equivalents to the scope of the claim, each numerical parameter should at least be construed in light of the number of reported significant digits and by applying ordinary rounding techniques.

In the following discussion and in the claims, the terms “including” and “comprising” are used in an open ended fashion, and thus should be interpreted to mean “including, but not limited to.” Unless otherwise indicated, as used throughout this document, “or” does not require mutual exclusivity.

The terms uphole and downhole can be used to refer to the location of various components relative to the bottom or end of a well. For example, a first component described as uphole from a second component can be further away from the end of the well than the second component. Similarly, a first component described as being downhole from a second component can be located closer to the end of the well than the second component. The term “downhole” as used herein refers to under the surface of the earth, such as a location within or fluidly connected to a wellbore.

If there is any conflict in the usages of a word or term in this specification and one or more patent or other documents that may be incorporated herein by reference, the definitions that are consistent with this specification should be adopted.

The production of water with hydrocarbons, i.e., oil and/or gas, from wells constitutes a major problem and expense in the production of the hydrocarbons. While hydrocarbon producing wells are usually completed in hydrocarbon producing formations, when the formations contain layers of water and oil or when there are water producing zones near the hydrocarbon producing formations, the higher mobility of the water often allows it to flow into the wellbores which penetrate the hydrocarbon producing formations by way of natural fractures and/or high permeability streaks. In the production of such wells, the ratios of water to hydrocarbons recovered often become so high that the cost of producing the water, separating it from the hydrocarbons and disposing of it can represent a significant economic loss.

To reduce the production of undesired water from hydrocarbon producing formations, aqueous polymer solutions containing cross-linking agents have been utilized heretofore. In the case of naturally fractured formations, such aqueous polymer solutions have been pumped into the hydrocarbon producing formations so that they enter water zones within and adjacent to the formations and cross-link therein. The cross-linking of the polymer solutions causes them to form stiff gels which aid in stopping or reducing the flow of the undesired water. While the use of aqueous polymer solutions for reducing the production of undesired water has achieved varying degrees of success, the full blocking gels produced are not suitable for producing formation treatments unless the polymer solution can be placed solely in the offending water producing zone or zones therein. If a polymer solution is allowed to gel within a hydrocarbon producing zone, the cross-linked polymer gel formed will reduce or stop the flow of hydrocarbons in addition to the flow of water. The selected placement of a polymer solution in a producing formation requires expensive, time-consuming zonal isolation placement technology. In addition, even when a polymer solution is properly placed in a water producing zone, the cross-linked gels formed often do not remain stable in the zone due to thermal degradation and/or differences in the adsorption characteristics of the polymer and associated cross-linker and the like.

Chemicals referred to as relative permeability modifiers can be utilized to decrease the production of water with hydrocarbons. That is, water permeability modifying chemicals such as polyacrylamide can be introduced into hydrocarbon and water producing formations so that the chemicals attach to adsorption sites on surfaces within the porosity of the formations. The presence of the chemicals in the formations can reduce the flow of water through the formations, while having a minimal affect on the flow of hydrocarbons therethrough. The use of water permeability modifying chemicals in hydrocarbon and water producing formations to decrease the production of water can be considerably less expensive than other techniques, such as blocking the flow of water with cross-linked polymers, and does not require expensive zonal isolation techniques. However, the use of conventional hydrophilic water permeability modifying chemicals, e.g., polyacrylamides, have heretofore resulted in only small reductions in water production and/or unacceptable levels of reduction in hydrocarbon production.

The present disclosure provides improved methods of treating water and hydrocarbon producing subterranean formations utilizing water permeability modifying chemicals which are effective in reducing water production with minimal or no reduction in hydrocarbon production, and thus meet the needs and overcome the deficiencies described above.

The methods of this disclosure comprise introducing into a hydrocarbon and water producing formation a water flow resisting chemical (also referred to herein as a “relative permeability modifier” or “RPM”) comprised of a polymer (also referred to herein as a “hydrophobically modified polymer”) made from a combination of at least one hydrophilic monomer and at least one hydrophobic monomer. The water flow resisting chemical is also referred to herein as a relative permeability modifier, as it can attach to adsorption sites on surfaces within the porosity of the formation and reduce the water permeability thereof without substantially reducing the hydrocarbon permeability thereof.

The polymer utilized can be introduced into the formation to be treated in an aqueous carrier liquid solution and overflushed with a water compatible with the formation. After the formation is contacted with the solution and the polymer has attached to surfaces within the porosity of the formation, a secondary overflush of a hydrocarbon such as diesel oil (or a gas in the case of a hydrocarbon gas producing formation) can be introduced therein to facilitate the subsequent production of hydrocarbons therethrough.

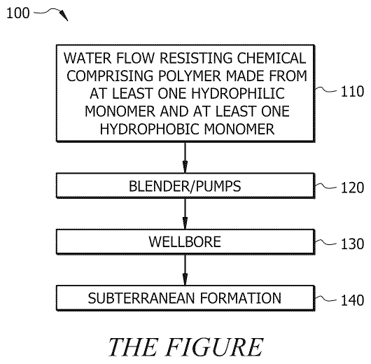

It is, therefore, a general object of the present disclosure to provide improved methods of reducing subterranean formation water permeability. As discussed further hereinbelow, in embodiments, the subterranean formation (140 of FIG. 1, described hereinbelow) comprises a metal carbonate. For example, the metal carbonate of the formation can include calcium carbonate, iron carbonate, magnesium calcium carbonate, strontium carbonate, calcite, dolomite, mixed carbonate/silicate, layered carbonate/silicate, or a combination thereof.

The present disclosure provides improved methods of treating water and hydrocarbon producing subterranean formations to reduce the water permeability of the formation without substantially reducing the hydrocarbon permeability (e.g., the water permeability of the formation is reduced more than the oil permeability of the formation). In embodiments, the water permeability of the formation is reduced by at least 20, 30, 40, 50 60, 70, 80, or 90%, and/or is reduced by an amount in a range of from about 30, 40, or 50% to about 70, 80, 90, or 99%, while the hydrocarbon permeability of the formation is reduced by less than or equal to 0, 10, 20, 30, 40, or 50%, and/or is reduced by an amount in a range of from about 0, 10, or 20% to about 10, 20, 30, 40, or 50%. In embodiments, the reduction in the water permeability of the formation is 1.5, 2, or 3 times the reduction in the hydrocarbon permeability of the formation. The term “water” when used in reference to the water produced with hydrocarbons from subterranean formations includes salt water and brines.

The methods of this disclosure basically comprise the step of introducing into the formation a water flow resisting chemical comprised of a polymer made from a combination of at least one hydrophilic monomer and at least one hydrophobic monomer which attaches to adsorption sites on surfaces within the porosity of the formation. The presence of the polymer in the formation reduces the flow of water therethrough. In embodiments, the hydrophobic monomer comprises a hydrophilic monomer that has been hydrophobically modified to provide the hydrophobic monomer.

The polymers useful in accordance with this disclosure can be prepared from a variety of hydrophilic monomers and hydrophobic monomers.

In embodiments, (a) the at least one hydrophilic monomer comprises N-vinyl formamide; (b) the at least one hydrophobic monomer comprises styrene, butadiene, 1-vinylnaphthalene, or a combination thereof; or (c) both (a) and (b).

In embodiments, (a) the at least one hydrophilic monomer comprises N-vinyl formamide. In such embodiments, the at least one hydrophilic monomer can further comprise acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof. In some such embodiments in which the at least one hydrophilic monomer comprises N-vinyl formamide, the hydrophobic monomer can comprise any hydrophobic monomers noted herein.

In embodiments, (b) the at least one hydrophobic monomer can comprise styrene, butadiene, 1-vinylnaphthalene, or a combination thereof. In such embodiments, the at least one hydrophobic monomer can further include one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof. For example, in embodiments, the at least one hydrophobic monomer can comprise one or more straight or branched alkyl or alkylaryl alcohol esters of acrylic or methacrylic acid, straight or branched alkyl or alkylaryl amides of acrylamide or methacrylamide, styrene, butadiene, 1-vinylnaphthalene, or a combination thereof. In some embodiments comprising (b), the hydrophilic monomer can comprise any hydrophilic monomers noted herein.

In embodiments, (a) the at least one hydrophilic monomer comprises N-vinyl formamide, and (b) the at least one hydrophobic monomer comprises styrene, butadiene, 1-vinylnaphthalene, or a combination thereof. In such embodiments, the at least one hydrophilic monomer can further comprise one or more additional hydrophilic monomers, such as noted herein, and/or one or more hydrophobic monomers, such as noted herein. For example, in some embodiments comprising (a) the at least one hydrophilic monomer comprises N-vinyl formamide, and (b) the at least one hydrophobic monomer comprises styrene, butadiene, 1-vinylnaphthalene, or a combination thereof, the at least one hydrophilic monomer can further comprise acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof, and/or the at least one hydrophobic monomer can further include one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

The water flow resisting chemical can comprise a hydrophobically-modified associative polymer (AP) that is water-soluble, but includes one or more water-insoluble short blocks. In embodiments, the water-soluble part can comprise acrylamide, methacrylamide, acrylic acid, methacrylic acid, 2-acrylamidomethylpropanesulfonic acid, N-vinyl pyrrolidone, N-vinyl formamide, and mixtures thereof. In embodiments, the water insoluble part having hydrophobic properties can comprise styrene, butadiene, 1-vinylnaphthalene or mixtures thereof.

In embodiments, the hydrophobically-modified associative polymer can be a copolymer including monomers selected from anionic monomers, cationic monomers, nonionic monomers, hydrophobically-modified monomers, and combinations thereof. Non-limiting examples of anionic monomers include anionic forms of acrylic acid and 2-acrylamido-2-methylpropane sulfonic acid (e.g., acrylate and 2-acrylamido-2-methylpropane sulfonate). A non-limiting example of a nonionic monomer includes acrylamide. A non-limiting example of a cationic monomer includes acryloyloxyethyltrimethylammonium chloride (AETAC). In an embodiment, the hydrophobically-modified monomer is an anionic monomer (e.g. acrylic acid) linked to a hydrophobe via direct carbon-carbon bond, ester bond or amide bond. Non-limiting examples of such hydrophobic monomers include, but not limited to, stearyl acrylate, octadecyl dimethyl allyl ammonium chloride, and n-lauryl-2-methyl-acrylamide. An example of a hydrophobically-modified associative polymer (AP) is poly(acrylic acid) co-(2-acrylamido-2-methylpropanesulfonic acid) with ethylhexyl acrylate as the hydrophobic monomer. Non-limiting, illustrative hydrophobic monomers are provided below.

As noted above, a variety of hydrophilic monomers can also be utilized to form the polymers useful in accordance with this disclosure. Suitable hydrophilic monomers include N-vinyl formamide, acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

As noted above, a variety of hydrophobic monomers can also be utilized to form the polymers useful in accordance with this disclosure. Suitable hydrophobic monomers include, but are not limited to, straight or branched alkyl or alkylaryl alcohol esters of acrylic or methacrylic acid, straight or branched alkyl or alkylaryl amides of acrylamide or methacrylamide, styrene, butadiene, 1-vinylnaphthalene, alkyl acrylates, alkyl methacrylates, alkyl acrylamides and alkyl methacrylamides wherein the alkyl radicals have from about 4 to about 22 carbon atoms, alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms, alkyl dimethylammonium-propylmethacrylamide bromide, alkyl dimethylammonium propylmethacrylamide chloride and alkyl dimethylammonium-propylmethacrylamide iodide wherein the alkyl groups have from about 4 to about 22 carbon atoms; or a combination of one or more thereof.

In an embodiment, the at least one hydrophobic monomer includes one or more hydrophobic monomers having a structure according to Formulae (I)-(V) below.

In embodiments, the at least one hydrophobic monomer includes a hydrophobic monomer according to Formula I:

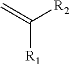

wherein R₁ is selected from H or CH₃ and R₂ is selected from:
(i) esters of α,β-ethylenically unsaturated, branched or straight mono- or dicarboxylic acid with C₂-C₃₀ alkanols (for example n-undecyl (meth)acrylate, ethylhexyl (meth)acrylate);
(ii) esters of vinyl or allyl alcohol with C₁-C₃₀ monocarboxylic acids, for example vinyl formate;
(iii) primary amides of α,β-ethylenically unsaturated mono- and dicarboxylic acids and N-alkyl and N,N-dialkyl derivatives, such as N-propyl (meth)acrylamide;
(iv) N-vinyllactams and its derivatives, such as N-vinyl-5-ethyl-2-pyrrolidone;
(v) esters of α,β-ethylenically unsaturated mono- and dicarboxylic acids with aminoalcohols, for example N,N-dimethylaminocyclohexyl (meth)acrylate;
(vi) amides of α,β-ethylenically unsaturated mono- and dicarboxylic acids with diamines comprising at least one primary or secondary amino group, for example N-[4-(dimethylamino)butyl] acrylamide; and
(vii) C₂ to C₈ monoolefins and nonaromatic hydrocarbons comprising at least two conjugated double bonds, for example ethylene, isobutylene and the like.

In embodiments, the at least one hydrophobic monomer includes a hydrophobic monomer according to Formula II:

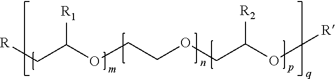

where m, n, p and q are integers and m, n, p are less than 150, q is greater than 0, and at least one integer among m, n and p is non-zero, R has a polymerizable vinylic function, R₁, and R₂ are identical or different, and represent hydrogen atoms or alkyl groups; R′ is a hydrophobic group comprising at least 6 and at most 36 carbon atoms, alternatively at least 12 and at most 24 carbon atoms, or alternatively at least 12 and at most 18 carbon atoms.

In embodiments, the at least one hydrophobic monomer includes a hydrophobic monomer according to Formula III:

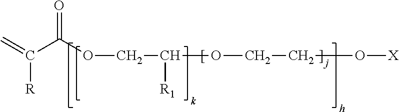

wherein R is H or CH₃; wherein R₁ is a —(CH₂)pH alkyl chain; wherein p is an integer from 1 to about 4; wherein j is an integer from 1 to about 50; wherein k is an integer from 0 to about 20, wherein h is 1 or 2; and wherein X has the following structure:

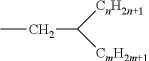

wherein m and n are, independently, positive integers from 1 to 39 and m+n represents an integer from 4 to 40.

In embodiments, the at least one hydrophobic monomer includes a hydrophobic monomer according to Formula IV:

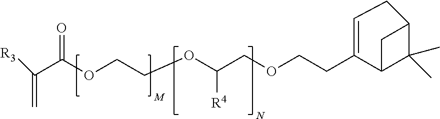

wherein R₃ is H or CH₃; R₄ is an alkyl chain containing 1 to about 4 carbons; M is an integer from 1 to about 50; and N is 0 or an integer of less than or equal to M. In embodiments, the R₄ group is on the immediately adjacent carbon (e.g., the carbon just to the right of its position in Formula IV above).

In embodiments, the at least one hydrophobic monomer includes a hydrophobic monomer according to Formula V:

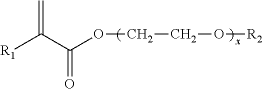

wherein R₁ is H or CH₃; x is an integer from 5 to about 50, R₂ is an alkyl chain containing 1 to about 32 carbons or a cycloalkyl ring or a single aromatic 4-6 membered ring.

Polymers which are useful in accordance with the present disclosure can be prepared by polymerizing any one or more of the above noted hydrophilic monomers with any one or more of the above noted hydrophobic monomers. While the polymerization reaction can be performed in various ways, an example of a particularly suitable procedure for polymerizing water soluble monomers is as follows. Into a 250 mL-3 neck round bottom flask, charge the following: 47.7 g DI water, 1.1 g acrylamide and 0.38 g alkyl dimethylammoniumethyl methacrylate bromide. The solution formed is sparged with nitrogen for approximately 30 minutes, followed by the addition of 0.0127 g of 2,2′-azobis (2-amidinopropane) dihydrochloride. The resulting solution can then be heated, with stirring, to 110° F. and held for 18 hours to produce a highly viscous polymer solution.

When the hydrophobic monomer is not water soluble, e.g., octadecylmethacrylate, the following procedure can be utilized. Into a (e.g., 250 mL-3 neck round bottom) flask, charge the following: (e.g., 41.2 g) DI water and (e.g., 1.26 g) acrylamide. The solution formed can then be sparged (e.g., with nitrogen for approximately 30 minutes), followed by the addition of (e.g., 0.06 g of) octadecyl methacrylate and (e.g., 0.45 g of a cocoamidopropyl betaine) surfactant. The mixture can be stirred until a homogeneous, clear solution is obtained followed by the addition of (e.g., 0.0055 g of) 2,2′-azobis (2-amidinopropane) dihydrochloride. The resulting solution can then be heated, with stirring, (e.g., to 110° F. and held for 18 hours) to produce a highly viscous polymer solution.

In addition, the polymerization procedure may employ a hydrocarbon reaction medium instead of water. In this case, appropriate surfactants are used to emulsify the hydrophilic/hydrophobic monomers, and the product is obtained as an oil external/water internal emulsion.

Suitable polymers prepared as described above have estimated molecular weights in the range of from about 250,000 to about 10,000,000, from about 100,000 to about 10,000,000, or from about 250,000 to about 3,000,000, and/or can have mole ratios of the hydrophilic monomer(s) to the hydrophobic monomer(s) in the range of from about 99.98:0.02 to about 80:20, from about 99.98:0.02 to about 90:10, or from about 95:5 to about 85:15.

An improved method of this disclosure for treating a water and hydrocarbon producing subterranean formation to reduce the water permeability thereof without substantially reducing the hydrocarbon permeability thereof can comprise the following steps. A polymer of at least one hydrophilic monomer and at least one hydrophobic monomer is prepared. The polymer can have a molecular weight in the range of from about 100,000 to about 10,000,000, from about 250,000 to about 10,000,000, or from about 250,000 to about 3,000,000, and can have a mole ratio of hydrophilic monomer(s) to hydrophobic monomer(s) in the range of from about 99.98:0.02 to about 80:20, from about 99.98:0.02 to about 90:10, or from about 95:5 to about 85:15 99.98:0.02 to about 90:10. Thereafter, the polymer is introduced into the subterranean formation to be treated so that the polymer attaches to adsorption sites on surfaces within the porosity of the formation (e.g., wherein the polymer adsorbs onto the surfaces within the porosity of the formation). The attachment can be electrostatic and/or (e.g., for some of the monomers at higher pH) ionic bonding to the surfaces. For example, for acrylic acid at pH greater than about 6 with carbonate the attachment could include ionic bond to calcium ions at the rock surfaces.

In carrying out the above described method, the polymer can, in embodiments, be dissolved in an aqueous carrier liquid and the resulting solution containing the polymer is introduced into the formation. The aqueous carrier liquid can be fresh water, seawater, or an aqueous salt solution. The aqueous carrier liquid can, without limitation, be an aqueous salt solution containing one or more salts in an amount in the range of from about 2% to about 10% by weight of the solution. A variety of salts can be utilized in the aqueous solution such as potassium chloride, sodium chloride, ammonium chloride and calcium chloride.

In order to facilitate the flow of the carrier liquid solution containing the polymer into the formation being treated, a surfactant can be included in the carrier fluid solution. As will be apparent to one of skill in the art and with the help of this disclosure, the surfactant can be selected for a specific application or location of the job. When used, the surfactant is included in the carrier liquid solution in an amount in the range of from about 0.10% to about 2.0% by weight of the solution, alternatively in an amount in the range of from about 0.5% to about 1%. After the treatment described above whereby the polymer utilized is adsorbed onto the formation surfaces, an after-flush of a hydrocarbon liquid such as kerosene, diesel oil or crude oil or a hydrocarbon or inert gas such as methane and natural gas or nitrogen (when the formation produces gas) can be introduced into the formation. Although optional in order for the polymer to be effective, the hydrocarbon liquid or gas after-flush in the formation can, in embodiments, facilitate the subsequent flow of hydrocarbons through the formation.

With reference to FIG. 1, which is a schematic of a wellbore servicing system 100, according to embodiments of this disclosure, a blender and/or pumps 120 can be utilized to introduce the water flow resisting chemical 110 comprising the polymer made from the at least one hydrophilic monomer and the at least one hydrophobic monomer into the wellbore 130 and/or subterranean formation 140. As described above, the water flow resisting chemical 110 of this disclosure, comprising the polymer, can be pumped via blenders/pumps 120 into the wellbore 130 and/or subterranean formation 140, whereby it attaches to adsorption sites on surfaces within the porosity of the formation 140 and/or reduces the water permeability thereof, without substantially reducing the hydrocarbon permeability. As noted above, in embodiments, the subterranean formation (140 of FIG. 1, described hereinbelow) comprises a metal carbonate. For example, the metal carbonate of the formation can include calcium carbonate, iron carbonate, magnesium calcium carbonate, strontium carbonate, calcite, dolomite, mixed carbonate/silicate, layered carbonate/silicate, or a combination thereof. Without limitation, the formation rock may in embodiments comprise a metal carbonate fraction of at least about 10, 20, 30, 40, or 50 percent metal carbonate, or more (and less than or equal to 100 percent metal carbonate). Such metal carbonate formations are not hydraulically fractured; and the water flow resisting chemical can be introduced into the formation 140 in a wellbore servicing fluid that does not contain particulates (e.g., proppant, such as sand or synthetic proppant utilized in hydraulic fracturing operations, or gravel utilized in gravel packing operations of less porous formations). The polymer of this disclosure formed from the at least one hydrophilic monomer and the at least one hydrophobic monomer is thus utilized as a relative permeability modifier, and not as a suspension aid (e.g., for suspending a proppant). The volume of the water flow resisting chemical 110 introduced into the formation can be substantially (e.g., at least 10, 20, 30, 40, or 50 percent, or more) less than an amount of fluid typically utilized in hydraulic fracturing or gravel packing operations.

In embodiments, the formation can have a permeability of greater than or equal to about 0.1, 0.5, 1, 2, 3, 4, 5, or 6 darcy and/or less than or equal to about 10, 15, or 20 darcy. In embodiments, the formation can be highly porous, for example, having a permeability of greater than or equal to at least 6, 7, 8, 9, or 10 darcy and/or less than or equal to about 10, 15, or 20 darcy. In embodiments, the water flow resisting chemical 110 of this disclosure is introduced into the formation 140 subsequent an acid treatment of the porous (e.g., metal carbonate) formation 140.

To facilitate a better understanding of the present embodiments, the following examples of certain aspects of some embodiments are given. In no way should the following examples be read to limit, or define, the entire scope of the embodiments.

### EXAMPLE

The present disclosure may be better understood by reference to the following Example, which is offered by way of illustration. The present disclosure is not limited to the Example provided herein.

Packs of calcium carbonate of approximately six centimeters in length were prepared by packing a cell with calcium carbonate particles and applying an overburden pressure of about 1000 psi. The cell was then heated to the target temperature. An aqueous solution of water and 2% potassium chloride salt by weight was prepared. The aqueous solution was flowed through the pack, and the initial permeability was determined. The pack was then treated with an RPM solution comprising a polymer/water flow resisting chemical of this disclosure. The polymer had a molecular weight of about 2 million. The aqueous salt solution was then again flowed through the pack and the final permeability to the aqueous solution was determined. The percent reduction in permeability to the aqueous solution was calculated as % reduction=((initial−final)/initial)*100. Table 1 shows the results of the tests.

TABLE 1
Core Flow Test Results of The Example

| | Initial | Final | | |
|---|---|---|---|---|
| | Water | Water | % | |
| | Perme- | Perme- | reduc- | |
| RPM | ability | ability | tion | Temperature |
| 20 ppt Polymer¹ | 14.6 darcy | 1.0 darcy | 93% | 190° F. (87.8° C.) |
| 20 ppt Polymer | 14.5 darcy | 2.2 darcy | 85% | 190° F. (87.8° C.) |
| 30 ppt Polymer | 14.6 darcy | 0.9 darcy | 94% | 205° F. (96.1° C.) |

¹ppt = pounds polymer per 1000 gallons of total solution

Thus, the present disclosure is well adapted to carry out the objects and attain the ends and advantages mentioned as well as those which are inherent therein. While numerous changes may be made by those skilled in the art, such changes are encompassed within the spirit of this disclosure as defined by the appended claims.

### Additional Disclosure

The following are non-limiting, specific embodiments in accordance with the present disclosure:

In a first embodiment, a method of treating a water and hydrocarbon producing subterranean formation to reduce the water permeability thereof comprises: introducing into the formation a water flow resisting chemical which attaches to adsorption sites on surfaces within the porosity of the formation and reduces the water permeability thereof without substantially reducing the hydrocarbon permeability, wherein the water flow resisting chemical comprises a polymer of at least one hydrophilic monomer and at least one hydrophobic monomer: (a) wherein the at least one hydrophilic monomer comprises N-vinyl formamide; (b) wherein the at least one hydrophobic monomer comprises styrene, butadiene, 1-vinylnaphthalene, or a combination thereof; or (c) both (a) and (b).

A second embodiment can include the method of the first embodiment, comprising (a), wherein the at least one hydrophilic monomer comprises N-vinyl formamide.

A third embodiment can include the method of the second embodiment, wherein the at least one hydrophobic monomer comprises one or more selected from styrene, butadiene, 1-vinylnaphthalene, alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof.

A fourth embodiment can include the method of the second or third embodiments, wherein the at least one hydrophilic monomer further comprises acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

A fifth embodiment can include the method of any one of the first to fourth embodiments, comprising (b), wherein the at least one hydrophobic monomer comprises styrene, butadiene, 1-vinylnaphthalene, or a combination thereof.

A sixth embodiment can include the method of the fifth embodiment, wherein the at least one hydrophilic monomer comprises N-vinyl formamide, acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

A seventh embodiment can include the method of the fifth or sixth embodiment, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

An eighth embodiment can include the method of any one of the first to seventh embodiments, comprising (a) wherein the at least one hydrophilic monomer comprises N-vinyl formamide, and (b) wherein the at least one hydrophobic monomer comprises styrene, butadiene, 1-vinylnaphthalene, or a combination thereof.

A ninth embodiment can include the method of the eighth embodiment, wherein the at least one hydrophilic monomer further comprises acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

A tenth embodiment can include the method of the ninth embodiment, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

An eleventh embodiment can include the method of any one of the eighth to tenth embodiments, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

A twelfth embodiment can include the method of any one of the first to eleventh embodiments, wherein the at least one hydrophobic monomer comprises a hydrophobic monomer having a structure according to Formula I:

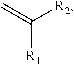

wherein R₁ is selected from H or CH₃ and R₂ is selected from: (i) esters of α,β-ethylenically unsaturated, branched or straight mono- or dicarboxylic acid with C₂-C₃₀ alkanols (for example n-undecyl (meth)acrylate, ethylhexyl (meth)acrylate); (ii) esters of vinyl or allyl alcohol with C₁-C₃₀ monocarboxylic acids, for example vinyl formate; (iii) primary amides of α,β-ethylenically unsaturated mono- and dicarboxylic acids and N-alkyl and N,N-dialkyl derivatives, such as N-propyl (meth)acrylamide; (iv) N-vinyllactams and its derivatives, such as N-vinyl-5-ethyl-2-pyrrolidone; (v) esters of α,β-ethylenically unsaturated mono- and dicarboxylic acids with aminoalcohols, for example N,N-dimethylaminocyclohexyl (meth)acrylate; (vi) amides of α,β-ethylenically unsaturated mono- and dicarboxylic acids with diamines comprising at least one primary or secondary amino group; and (vii) monoolefins and nonaromatic hydrocarbons comprising at least two conjugated double bonds.

A thirteenth embodiment can include the method of any one of the first to twelfth embodiments, wherein the at least one hydrophobic monomer comprises a hydrophobic monomer having a structure according to Formula II:

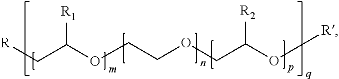

where m, n, p and q are integers and m, n, p are less than 150, q is greater than 0, and at least one integer among m, n and p is non-zero, R has a polymerizable vinylic function, R₁, and R₂ are identical or different, and represent hydrogen atoms or alkyl groups; R′ is a hydrophobic group comprising at least 6 and at most 36 carbon atoms, at least 12 and at most 24 carbon atoms, or at least 12 and at most 18 carbon atoms.

A fourteenth embodiment can include the method of any one of the first to thirteenth embodiments, wherein the at least one hydrophobic monomer comprises a hydrophobic monomer having a structure according to Formula III:

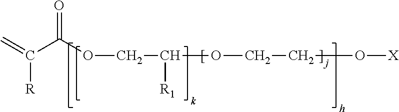

wherein R is H or CH₃; wherein R₁ is a —(CH₂)pH alkyl chain; wherein p is an integer from 1 to about 4; wherein j is an integer from 1 to about 50; wherein k is an integer from 0 to about 20, wherein h is 1 or 2; and wherein X has the following structure:

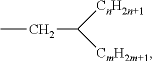

wherein m and n are, independently, positive integers from 1 to 39 and m+n represents an integer from 4 to 40.

A fifteenth embodiment can include the method of any one of the first to fourteenth embodiments, wherein the at least one hydrophobic monomer comprises a hydrophobic monomer having a structure according to Formula IV:

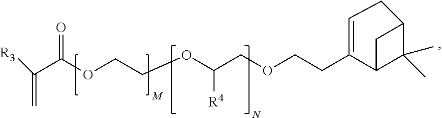

wherein R₃ is H or CH₃; R₄ is an alkyl chain containing 1 to about 4 carbons; M is an integer from 1 to about 50; and N is 0 or an integer of less than or equal to M, or an isomer thereof where R4 is moved to the immediately adjacent carbon.

A sixteenth embodiment can include the method of any one of the first to fifteenth embodiments, wherein the at least one hydrophobic monomer comprises a hydrophobic monomer having a structure according to Formula V:

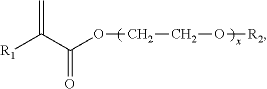

wherein R₁ is H or CH₃; x is an integer from 5 to about 50, R₂ is an alkyl chain containing 1 to about 32 carbons or a cycloalkyl ring or a single aromatic 4-6 membered ring.

A seventeenth embodiment can include the method of any one of the first to sixteenth embodiments, wherein the mole ratio of the at least one hydrophilic monomer to the at least one hydrophobic monomer in the polymer is in the range of from about 99.98:0.02 to about 80:20.

A eighteenth embodiment can include the method of any one of the first to seventeenth embodiments, wherein the polymer is dissolved in an aqueous carrier liquid.

A nineteenth embodiment can include the method of the eighteenth embodiment, wherein the aqueous carrier liquid comprises an aqueous salt solution.

An twentieth embodiment can include the method of the nineteenth embodiment, wherein the salt in the aqueous salt solution is selected from potassium chloride, sodium chloride, ammonium chloride, calcium chloride, or a combination thereof, and wherein the salt is present in the aqueous salt solution in an amount in the range of from about 2% to about 10% by weight of the solution.

A twenty first embodiment can include the method of any one of the eighteenth to twentieth embodiments, wherein the aqueous carrier liquid solution further comprises a surfactant dissolved therein.

A twenty second embodiment can include the method of the twenty first embodiment, wherein the surfactant is present in an amount in the range of from about 0.1% to about 2% by weight of the carrier liquid solution.

A twenty third embodiment can include the method of any one of the first to twenty second embodiments further comprising introducing a hydrocarbon liquid or a gas into the formation after the introduction of the water flow resisting chemical therein.

A twenty fourth embodiment can include the method of the twenty third embodiment, wherein the liquid hydrocarbon comprises kerosene, diesel oil, crude oil, or a combination thereof.

In a twenty fifth embodiment, a method of treating a water and hydrocarbon producing subterranean formation to reduce the water permeability thereof without substantially reducing the hydrocarbon permeability thereof comprises: providing (e.g., obtaining) a polymer of at least one hydrophilic monomer and at least one hydrophobic monomer, wherein the polymer has a molecular weight in the range of from about 100,000 to about 10,000,000; and introducing the polymer into the formation whereby the polymer attaches to adsorption sites on surfaces within the porosity of the formation, (a) wherein the at least one hydrophilic monomer comprises N-vinyl formamide; (b) wherein the at least one hydrophobic monomer comprises styrene, butadiene, 1-vinylnaphthalene, or a combination thereof; or (c) both (a) and (b).

A twenty sixth embodiment can include the method of the twenty fifth embodiment, wherein the polymer has a molecular weight in the range of from about 250,000 to about 3,000,000.

A twenty seventh embodiment can include the method of the twenty fifth or twenty sixth embodiment, comprising (a), wherein the at least one hydrophilic monomer comprises N-vinyl formamide.

A twenty eighth embodiment can include the method of the twenty seventh embodiment, wherein the at least one hydrophilic monomer further comprises acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

A twenty ninth embodiment can include the method of any one of the twenty fifth to twenty eighth embodiments comprising (b), wherein the at least one hydrophobic monomer comprises styrene, butadiene, 1-vinylnaphthalene, or a combination thereof.

A thirtieth embodiment can include the method of the twenty ninth embodiment, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

A thirty first embodiment can include the method of any one of the twenty fifth to thirtieth embodiments, comprising (a) wherein the at least one hydrophilic monomer comprises N-vinyl formamide, and (b) wherein the at least one hydrophobic monomer comprises styrene, butadiene, 1-vinylnaphthalene, or a combination thereof.

A thirty second embodiment can include the method of the thirty first embodiment, wherein the at least one hydrophilic monomer further comprises acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

A thirty third embodiment can include the method of the thirty second embodiment, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

A thirty fourth embodiment can include the method of any one of the thirty first to thirty third embodiments, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; straight or branched alkyl or alkylaryl alcohol esters of acrylic or methacrylic acid, straight or branched alkyl or alkylaryl amides of acrylamide or methacrylamide, or a combination thereof.

A thirty fifth embodiment can include the method of any one of the twenty fifth to thirty fourth embodiments, wherein the at least one hydrophobic monomer comprises a hydrophobic monomer having a structure according to Formula I:

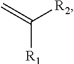

wherein R₁ is selected from H or CH₃ and R₂ is selected from: (i) esters of α,β-ethylenically unsaturated, branched or straight mono- or dicarboxylic acid with C₂-C₃₀ alkanols (for example n-undecyl (meth)acrylate, ethylhexyl (meth)acrylate); (ii) esters of vinyl or allyl alcohol with C₁-C₃₀ monocarboxylic acids, for example vinyl formate; (iii) primary amides of α,β-ethylenically unsaturated mono- and dicarboxylic acids and N-alkyl and N,N-dialkyl derivatives, such as N-propyl (meth)acrylamide; (iv) N-vinyllactams and its derivatives, such as N-vinyl-5-ethyl-2-pyrrolidone; (v) esters of α,β-ethylenically unsaturated mono- and dicarboxylic acids with aminoalcohols, for example N,N-dimethylaminocyclohexyl (meth)acrylate; (vi) amides of α,β-ethylenically unsaturated mono- and dicarboxylic acids with diamines comprising at least one primary or secondary amino group; and (vii) monoolefins (e.g., C₂-C₈ monoolefins) and nonaromatic hydrocarbons comprising at least two conjugated double bonds.

A thirty sixth embodiment can include the method of any one of the twenty fifth to thirty fifth embodiments, wherein the at least one hydrophobic monomer comprises a hydrophobic monomer having a structure according to Formula II:

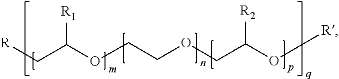

where m, n, p and q are integers and m, n, p are less than 150, q is greater than 0, and at least one integer among m, n and p is non-zero, R has a polymerizable vinylic function, R₁, and R₂ are identical or different, and represent hydrogen atoms or alkyl groups; R′ is a hydrophobic group comprising at least 6 and at most 36 carbon atoms, at least 12 and at most 24 carbon atoms, or at least 12 and at most 18 carbon atoms.

A thirty seventh embodiment can include the method of any one of the twenty fifth to thirty sixth embodiments, wherein the at least one hydrophobic monomer comprises a hydrophobic monomer having a structure according to Formula III:

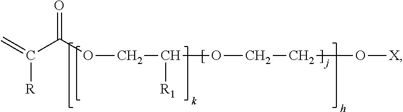

wherein R is H or CH₃; wherein R₁ is a —(CH₂)pH alkyl chain; wherein p is an integer from 1 to about 4; wherein j is an integer from 1 to about 50; wherein k is an integer from 0 to about 20, wherein h is 1 or 2; and wherein X has the following structure:

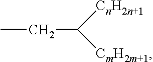

wherein m and n are, independently, positive integers from 1 to 39 and m+n represents an integer from 4 to 40.

A thirty eighth embodiment can include the method of any one of the twenty fifth to thirty seventh embodiments, wherein the at least one hydrophobic monomer comprises a hydrophobic monomer having a structure according to Formula IV:

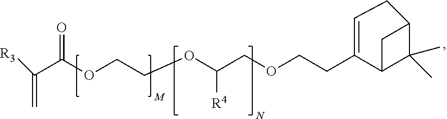

wherein R₃ is H or CH₃; R₄ is an alkyl chain containing 1 to about 4 carbons; M is an integer from 1 to about 50; and N is 0 or an integer of less than or equal to M, or an isomer thereof where R4 is moved to the immediately adjacent carbon.

A thirty ninth embodiment can include the method of any one of the twenty fifth to thirty eighth embodiments, wherein the at least one hydrophobic monomer comprises a hydrophobic monomer having a structure according to Formula V:

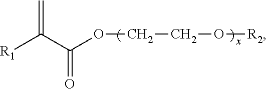

wherein R₁ is H or CH₃; x is an integer from 5 to about 50, R₂ is an alkyl chain containing 1 to about 32 carbons or a cycloalkyl ring or a single aromatic 4-6 membered ring.

A fortieth embodiment can include the method of any one of the twenty fifth to thirty ninth embodiments, wherein the mole ratio of the hydrophilic monomer to the hydrophobic monomer in the polymer is in the range of from about 99.98:0.02 to about 80:20.

A forty first embodiment can include the method of any one of the twenty fifth to fortieth embodiments, wherein the polymer is dissolved in an aqueous carrier liquid.

A forty second embodiment can include the method of the forty first embodiment, wherein the aqueous carrier liquid comprises an aqueous salt solution.

A forty third embodiment can include the method of the forty second embodiment, wherein the salt in the aqueous salt solution is selected from potassium chloride, sodium chloride, ammonium chloride, calcium chloride, or a combination thereof, and wherein the salt is present in the aqueous salt solution in an amount in a range of from about 2% to about 10% by weight of the solution.

A forty fourth embodiment can include the method of the forty first embodiment, wherein the aqueous carrier liquid solution further comprises a surfactant dissolved therein.

A forty fifth embodiment can include the method of the forty fourth embodiment, wherein the surfactant (e.g., comprises cocoylamidopropyl-betaine, and) is present in an amount in a range of from about 0.1% to about 2% by weight of the aqueous carrier liquid solution.

A forty sixth embodiment can include the method of any one of the twenty fifth to forty fifth embodiments further comprising introducing a hydrocarbon liquid or a gas into the formation after the introduction of the water flow resisting chemical therein.

A forty seventh embodiment can include the method of the forty sixth embodiment, wherein the liquid hydrocarbon comprises kerosene, diesel oil, crude oil, or a combination thereof.

A forty eighth embodiment can include the method of the forty sixth embodiment, wherein the gas is selected from methane, natural gas, nitrogen, or a combination thereof.

In a forty ninth embodiment, a method of treating a water and hydrocarbon producing subterranean formation to reduce the water permeability thereof comprises: introducing into the formation a water flow resisting chemical which attaches to adsorption sites on surfaces within the porosity of the formation and reduces the water permeability thereof without substantially reducing the hydrocarbon permeability, wherein the water flow resisting chemical comprises a polymer of at least one hydrophilic monomer and at least one hydrophobic monomer, (a) wherein the at least one hydrophilic monomer comprises N-vinyl formamide; (b) wherein the at least one hydrophobic monomer comprises one or more of hydrophobic monomers having a structure according to Formula (I)-(V); or (c) both (a) and (b),

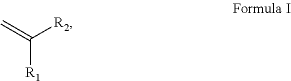

wherein R1 is selected from H or CH3 and R2 is selected from: (i) esters of α,β-ethylenically unsaturated, branched or straight mono- or dicarboxylic acid with C2-C30 alkanols (for example n-undecyl (meth)acrylate, ethylhexyl (meth)acrylate); (ii) esters of vinyl or allyl alcohol with C1-C30 monocarboxylic acids, for example vinyl formate; (iii) primary amides of α,β-ethylenically unsaturated mono- and dicarboxylic acids and N-alkyl and N,N-dialkyl derivatives, such as N-propyl (meth)acrylamide; (iv) N-vinyllactams and its derivatives, such as N-vinyl-5-ethyl-2-pyrrolidone; (v) esters of α,β-ethylenically unsaturated mono- and dicarboxylic acids with aminoalcohols, for example N,N-dimethylaminocyclohexyl (meth)acrylate; (vi) amides of α,β-ethylenically unsaturated mono- and dicarboxylic acids with diamines comprising at least one primary or secondary amino group; and (vii) monoolefins (e.g., C2-C8 monoolefins) and nonaromatic hydrocarbons comprising at least two conjugated double bonds,

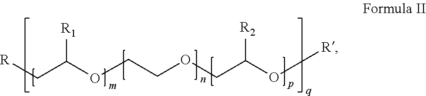

where m, n, p and q are integers and m, n, p are less than 150, q is greater than 0, and at least one integer among m, n and p is non-zero, R has a polymerizable vinylic function, R₁, and R₂ are identical or different, and represent hydrogen atoms or alkyl groups; R′ is a hydrophobic group comprising at least 6 and at most 36 carbon atoms, at least 12 and at most 24 carbon atoms, or at least 18 and at most 22 carbon atoms,

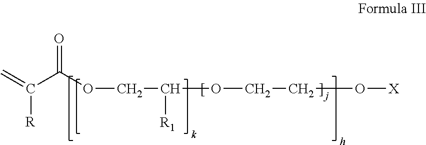

wherein R is H or CH₃; wherein R₁ is a —(CH₂)pH alkyl chain; wherein p is an integer from 1 to about 4; wherein j is an integer from 1 to about 50; wherein k is an integer from 0 to about 20, wherein h is 1 or 2; and wherein X has the following structure:

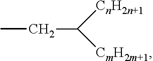

wherein m and n are, independently, positive integers from 1 to 39 and m+n represents an integer from 4 to 40,

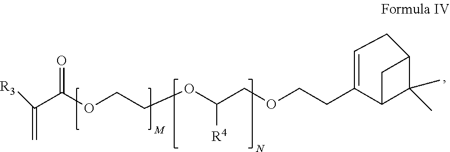

wherein R₃ is H or CH₃; R₄ is an alkyl chain containing 1 to about 4 carbons; M is an integer from 1 to about 50; and N is 0 or an integer of less than or equal to M, or an isomer thereof where R4 is moved to the immediately adjacent carbon,

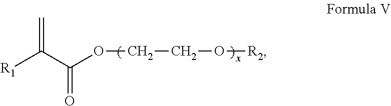

wherein R₁ is H or CH₃; x is an integer from 5 to about 50, R₂ is an alkyl chain containing 1 to about 32 carbons or a cycloalkyl ring or a single aromatic 4-6 membered ring.

In a fiftieth embodiment, a method of treating a water and hydrocarbon producing subterranean formation to reduce the water permeability thereof comprises: introducing into the formation a water flow resisting chemical which attaches to adsorption sites on surfaces within the porosity of the formation and reduces the water permeability thereof without substantially reducing the hydrocarbon permeability, wherein the water flow resisting chemical comprises a polymer of at least one hydrophilic monomer and at least one hydrophobic monomer: (a) wherein the at least one hydrophilic monomer comprises N-vinyl formamide, and optionally wherein the at least one hydrophobic monomer comprises styrene, butadiene, 1-vinylnaphthalene, alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof; (b) wherein the at least one hydrophobic monomer comprises styrene, butadiene, 1-vinylnaphthalene, or a combination thereof; and optionally wherein the at least one hydrophilic monomer comprises N-vinyl formamide, acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof; or (c) both (a) and (b).

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of treating a water and hydrocarbon producing subterranean formation to reduce the water permeability thereof, the method comprising:
introducing into the formation a water flow resisting chemical which attaches to adsorption sites on surfaces within the porosity of the formation and reduces the water permeability thereof without substantially reducing the hydrocarbon permeability,
wherein the water flow resisting chemical comprises a polymer of at least one hydrophilic monomer and at least one hydrophobic monomer: (a) wherein the at least one hydrophilic monomer comprises N-vinyl formamide; or (b) wherein the at least one hydrophobic monomer comprises styrene, butadiene, 1-vinylnaphthalene, or a combination thereof; or (c) both (a) and (b).

2. The method of claim 1 comprising (a), wherein the at least one hydrophilic monomer comprises N-vinyl formamide.

3. The method of claim 2, wherein the at least one hydrophobic monomer comprises one or more selected from styrene, butadiene, 1-vinylnaphthalene, alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof.

4. The method of claim 2, wherein the at least one hydrophilic monomer further comprises acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

5. The method of claim 1 comprising (b), wherein the at least one hydrophobic monomer comprises styrene, butadiene, 1-vinylnaphthalene, or a combination thereof.

6. The method of claim 5, wherein the at least one hydrophilic monomer comprises N-vinyl formamide, acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

7. The method of claim 5, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof.

8. The method of claim 1, comprising (a) wherein the at least one hydrophilic monomer comprises N-vinyl formamide, and (b) wherein the at least one hydrophobic monomer comprises styrene, butadiene, 1-vinylnaphthalene, or a combination thereof.

9. The method of claim 8, wherein the at least one hydrophilic monomer further comprises acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof.

10. The method of claim 9, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof.

11. The method of claim 8, wherein the at least one hydrophobic monomer further includes one or more of: alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof.

12. The method of claim 1, wherein the at least one hydrophobic monomer comprises a hydrophobic monomer having a structure according to Formula I: 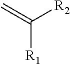
wherein R₁ is selected from H or CH₃ and R₂ is selected from:
(i) esters of α,β-ethylenically unsaturated, branched or straight mono- or dicarboxylic acid with C₂-C₃₀ alkanols;
(ii) esters of vinyl or allyl alcohol with C₁-C₃₀ monocarboxylic acids;
(iii) primary amides of α,β-ethylenically unsaturated mono- and dicarboxylic acids and N-alkyl and N,N-dialkyl derivatives;
(iv) N-vinyllactams and its derivatives;
(v) esters of α,β-ethylenically unsaturated mono- and dicarboxylic acids with aminoalcohols;
(vi) amides of α,β-ethylenically unsaturated mono- and dicarboxylic acids with diamines comprising at least one primary or secondary amino group; and
(vii) monoolefins and nonaromatic hydrocarbons comprising at least two conjugated double bonds.

13. The method of claim 1, wherein the at least one hydrophobic monomer comprises a hydrophobic monomer having a structure according to Formula II: 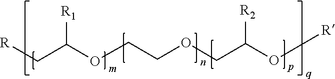
where m, n, p and q are integers and m, n, p are less than 150, q is greater than 0, and at least one integer among m, n and p is non-zero, R has a polymerizable vinylic function, R₁, and R₂ are identical or different, and represent hydrogen atoms or alkyl groups; and R′ is a hydrophobic group comprising at least 6 and at most 36 carbon atoms.

14. The method of claim 1, wherein the at least one hydrophobic monomer comprises a hydrophobic monomer having a structure according to Formula III: 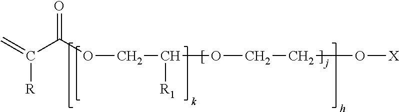
wherein R is H or CH₃; wherein R₁ is a —(CH₂)pH alkyl chain; wherein p is an integer from 1 to about 4; wherein j is an integer from 1 to about 50; wherein k is an integer from 0 to about 20, wherein h is 1 or 2; and wherein X has the following structure: 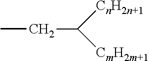
wherein m and n are, independently, positive integers from 1 to 39 and m+n represents an integer from 4 to 40.

15. The method of claim 1, wherein the at least one hydrophobic monomer comprises a hydrophobic monomer having a structure according to Formula IV: 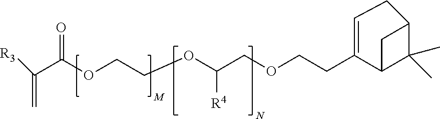
wherein R₃ is H or CH₃; R₄ is an alkyl chain containing 1 to about 4 carbons; M is an integer from 1 to about 50; and N is 0 or an integer of less than or equal to M, or an isomer thereof where R₄ is moved to the immediately adjacent carbon.

16. The method of claim 1, wherein the at least one hydrophobic monomer comprises a hydrophobic monomer having a structure according to Formula V: 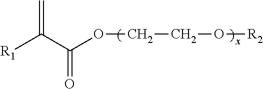
wherein R₁ is H or CH₃; x is an integer from 5 to about 50, and R₂ is an alkyl chain containing 1 to about 32 carbons or a cycloalkyl ring or a single aromatic 4-6 membered ring.

17. A method of treating a water and hydrocarbon producing subterranean formation to reduce the water permeability thereof without substantially reducing the hydrocarbon permeability thereof, the method comprising:
providing a polymer of at least one hydrophilic monomer and at least one hydrophobic monomer, wherein the polymer has a molecular weight in the range of from about 100,000 to about 10,000,000; and
introducing the polymer into the formation whereby the polymer attaches to adsorption sites on surfaces within the porosity of the formation,
(a) wherein the at least one hydrophilic monomer comprises N-vinyl formamide;
(b) wherein the at least one hydrophobic monomer comprises styrene, butadiene, 1-vinylnaphthalene, or a combination thereof; or
(c) both (a) and (b).

18. The method of claim 17:
comprising (a), wherein the at least one hydrophilic monomer comprises N-vinyl formamide; or
comprising (a) wherein the at least one hydrophilic monomer comprises N-vinyl formamide, and (b) wherein the at least one hydrophobic monomer comprises styrene, butadiene, 1-vinylnaphthalene, or a combination thereof.

19. The method of claim 17:
comprising (b), wherein the at least one hydrophobic monomer comprises styrene, butadiene, 1-vinylnaphthalene, or a combination thereof; and/or
wherein the mole ratio of the hydrophilic monomer to the hydrophobic monomer in the polymer is in the range of from about 99.98:0.02 to about 80:20.

20. A method of treating a water and hydrocarbon producing subterranean formation to reduce the water permeability thereof, the method comprising:
introducing into the formation a water flow resisting chemical which attaches to adsorption sites on surfaces within the porosity of the formation and reduces the water permeability thereof without substantially reducing the hydrocarbon permeability,
wherein the water flow resisting chemical comprises a polymer of at least one hydrophilic monomer and at least one hydrophobic monomer: (a) wherein the at least one hydrophilic monomer comprises N-vinyl formamide, and wherein the at least one hydrophobic monomer comprises one or more selected from styrene, butadiene, 1-vinylnaphthalene, alkyl acrylates, alkyl methacrylates, alkyl acrylamides and alkyl methacrylamides wherein the alkyl radicals have from about 4 to about 22 carbon atoms; alkyl dimethylammoniumethyl methacrylate bromide, alkyl dimethylammoniumethyl methacrylate chloride and alkyl dimethylammoniumethyl methacrylate iodide wherein the alkyl radicals have from about 4 to about 22 carbon atoms; alkyl dimethylammonium propylmethacrylamide bromide, alkyl dimethylammonium propylmethacrylamide chloride and alkyl dimethylammonium propylmethacrylamide iodide wherein the alkyl groups have from about 4 to about 22 carbon atoms; from straight or branched alkyl or alkylaryl alcohol esters of acrylic or methacrylic acid, straight or branched alkyl or alkylaryl amides of acrylamide or methacrylamide, or a combination thereof; or (b) wherein the at least one hydrophobic monomer comprises styrene, butadiene, 1-vinylnaphthalene, or a combination thereof; and wherein the at least one hydrophilic monomer comprises N-vinyl formamide, acrylamide, 2-acrylamido-2-methyl propane sulfonic acid, N,N-dimethylacrylamide, vinyl pyrrolidone, dimethylaminoethyl methacrylate, acrylic acid, dimethylaminopropylmethacrylamide, trimethylammoniumethyl methacrylate chloride, methacrylamide and hydroxyethyl acrylate, or a combination thereof; or (c) both (a) and (b).
